(19) United States
(12) Patent Application Publication
(10) Pub. No.: US 2010/0063739 A1
(43) Pub. Date: Mar. 11, 2010

(54) METHOD FOR PREDICTING WHERE THE NEXT MAJOR EARTHQUAKE WILL TAKE PLACE WITHIN AN AREA

(76) Inventor: Ragnar Slunga, Stockholm (SE)

Correspondence Address: JACOBSON HOLMAN PLLC, 400 SEVENTH STREET N.W., SUITE 600, WASHINGTON, DC, 20004, US

(21) Appl. No.: 12/312,465

(22) PCT Filed: Oct. 31, 2007
(86) PCT No.: PCT/SE2007/000964

§ 371 Date: May 12, 2009

(30) Foreign Application Priority Data
Nov. 14, 2006 (SE) 0602417-8

(51) Int. Cl. G01V 1/28

(52) U.S. Cl. 702/15

(57) ABSTRACT

The present invention relates to a method of predicting where the next major earthquake will occur within a area based on knowledge of the stress tensor field in the area, including determining stress tensors that have caused a shear slip in the form of an earthquake. It is first assumed that said first shear slip is the only one that is not stable according the Mohr-Coulomb slip criterion applied to contemplated fault planes with all conceivable orientations and calculating according to the Mohr-Coulomb slip criterion the principal stress directions as a function of the friction coefficient f. After that, it is established according to the Mohr-Coulomb slip criterion a relationship between two of the principal stresses. Moreover the normal stress σv in a known direction Sv is determined and, according to the elasticity theory, a relationship between the normal stress σv and the principal stresses is established. Then expressions of the three principal stresses as a function of a scalar parameter is established, and a function of the elastic deformation energy per unit of volume relative to an isotropic reference stress state with the pressure σv based on the expressions of the principal stresses is established. Finally, the remaining degree of freedom is eliminated by determining the value of said scalar parameter which minimises the function of the elastic deformation energy and the value of the scalar parameter in the expressions of the principal stresses is inserted.

The present invention relates to a method of determining the stress tensor that has caused an earthquake, also for microearthquakes which are many more than the large earthquakes. When a great number of microearthquakes are available, the entire stress tensor field can be determined, which may be used, inter alia, to predict where the next major earthquake will occur.

The stress tensor field in an elastic body (for instance the earth crust) is directly associated with the deformations and besides gives the stability on all existing fault planes. A crucial part in geophysics is played by shear slips along fault planes, for instance microearthquakes (magnitudes between normally −2 and 5). Such a shear slip observation is described geometrically by three parameters, the normal direction of the fault plane (2 angles) plus the shear slip direction along the plane (1 angle). It is suitable to let each shear slip observation be described by two unit vectors, the normal N of the plane and the shear slip vector D. These vectors are perpendicular to each other and are thus given by three parameters. For microearthquakes, usually only the fault plane solution (FPS) of the earthquake is available, which means that you have the two unit vectors, but that it is unknown which of them is N and which is D.

There is no prior art method that gives the entire stress tensor for individual earth-quakes based on the fault plane solution or on fault plane orientation and shear slip direction, although this problem has been discussed for decades and although in many applications of earthquake analysis the relationship between the shear slip mechanisms and the rock stress field is discussed.

The methods that are normally used require assuming that four or more earth-quakes (shear slips on fractures) with different fault plane orientations have been caused by one and the same stress tensor. In addition, these methods do not provide the entire one and the same stress tensor but only the principal stress directions plus the so-called shape factor

$$R = \frac{{σ}_{2} - {σ}_{3}}{{σ}_{1} - {σ}_{3}}$$

wherein σ₁, σ₂ and σ₃ are the still unknown principal stresses, that is only 4 of 6 parameters in the stress tensor are determined. For a person who, in contrast to a person skilled in the art, is not familiar with this calculation, reference is made to Angelier and Gougel, 1978, Sur une methode simple de determination des axes principaux des constraintes pour une population de failles, C. r. hebd. Seanc. Acad. Sci. Paris, 288, pp 307-310 and to Gephart and Forsythe, 1982, An improved method for determining the regional stress tensor using earthquake focal mechanism data: application to the San Fernando earthquake sequence, J. Geophys. Res., 89, pp 9305-9320, both hereby incorporated by reference.

All experience of stress tensor fields in the earth crust and/or rock mass demon-strates that this is so heterogeneous that the assumption of a constant stress tensor for different faults cannot be justified. It should also be observed that these prior art methods imply that the orientation and shear slip direction of the fault plane are not (!) optimal for the causing stress tensor. The case that the fault plane and the shear slip direction are optimal is dismissed as a single case without importance, which is known to a person skilled in the art, but may, for a person who is less familiar with this, be studied in Gephart, 1985, Principle stress directions and the ambiguity in fault plane identification from focal mechanisms, Bull. Seism. Soc. Am., 75, pp 621-625, hereby incorporated by reference.

The present invention provides a new solution to the problem of determining the stress tensor that has caused a shear slip along a fault plane (an earthquake or a microearthquake) when two unit vectors are known and you know that one is the normal N of the fault plane and the other the shear slip vector D, but it is not necessarily known which vector is N and which is D. The vectors are perpendicular to each other. The method provides the entire stress tensor (six parameters, that is three principal stress directions and their respective principal stress) for each individual shear slip (earthquake). If only the FPS is available for an earthquake, which as stated above means that there are two possible fault planes with an associated shear slip direction, the method also indicates which of the two planes is the shear slip plane. When a large number of microearthquakes are available and their FPS has been determined, which is a routine analysis according to prior art technique, the entire stress tensor field can be determined.

The invention solves the problem set forth by being designed in the way that is evident from the following independent claim. The remaining claims concern advantageous embodiments of the invention.

A basic review of the inventive method will now be presented. We start from a given fault plane with the normal unit vector N and an associated shear slip direction given by the unit vector D which lies in the plane. In the FPS case, it is unclear which of the vectors is N and D respectively, which results in two possible fault planes. If it is not possible to determine which fault plane is the correct one, the calculations may continue for each of the two possible fault planes. The invention then provides, when the calculations are completed, a response to which fault plane is the correct one. This will be described later in the text.

The first step according to the invention is assuming that the relationship between the stress tensor and the shear slip (N, D) is such that Mohr-Coulomb slip criterion is just satisfied. All other combinations of planes and shear slip directions are assumed to be stable according to this slip criterion. The Mohr-Coulomb slip criterion directly gives the principal stress directions of the stress tensor as functions of the friction coefficient f of the fault plane, which is assumed to be known. The slip criterion also gives a connection between two of the principal stresses. Then there remains determining two degrees of freedom for the stress tensor.

The invention further assumes that the normal stress σᵥ in a known direction Sᵥ is known, which provides a further limiting criterion. It is usually the vertical normal stress that can most easily be estimated.

The remaining degree of freedom is eliminated by minimising a function of the elastic deformation energy per unit of volume relative to a reference stress state which in the main case is isotropic and has the pressure σᵥ. This means that the entire stress tensor will be determined. The 6 criteria (3 principal stress directions plus 1 criterion for the magnitude of the principal stresses from the Mohr-Coulomb slip criterion, 1 criterion from the assumption about σᵥ and 1 criterion from the minimising of energy) provide the 6 parameters in the stress tensor.

In many applications, there is reason to use also a non-isotropic reference stress in the expression of the deformation energy that is minimised. It is in many cases known which mechanism (N vector and D vector) a future major earthquake will have. For such a given reference mechanism defined by the vectors N^{ref} and D^{ref}, a new alternative reference stress tensor will first be determined according to the main case above with the deformation energy calculated relative to the isotropic reference stress state. Let σᵢ^{ref}, i=1, 2, 3, designate the three principal stresses and Sᵢ^{ref}, i=1, 2, 3, designate the three principal stress direction vectors for this alternative reference tensor. If the scalar s is determined by minimising the deformation energy relative to this alternative reference tensor, a cautious, conservative, estimate of how close you are to such an instability that can cause an earthquake with the mechanism N^{ref} D^{ref} will be obtained.

However, a more probable estimate of the stress tensor if there is information about a suitable reference mechanism, N^{ref}, D^{ref}, will be obtained by minimising a weighted sum of the deformation energies relative to the two references, the isotropic stress tensor and the non-isotropic reference tensor.

Instead of using principal stresses and principal stress directions, it will, of course, be possible to relate the tensor components to an arbitrary coordinate system, but at the price of greater complexity. The difference has nothing to do with the gist of the invention but is pure mathematics which only results in more complicated calculations. Therefore all discussions will in the following start from the principal stress case, while observing, however, that on a basic plane it is perfectly equivalent to use another coordinate system.

Embodiments of the invention will in the following be described in more detail.

### 1. Material Parameters for Rock and Fault Systems

E=elasticity module of the rock (normally about 90 GPa)
ν=Poisson ratio of the rock (normally about 0.25)
f=friction coefficient of faults (normally about 0.6)
t₀=fault strength in shear slip (normally 1-2 MPa)

### 2. The Fault Plane and the Parameters of the Shear Slip Direction

z=depth of the fault, z=0 at the surface
N=unit vector in the normal direction of the fault plane
D=unit vector which provides the shear slip direction, D lies in the fault plane

The directions of N and D are defined so that the vector N+D lies in the direction of the T vector and the vector N−D lies in the direction of the P vector, where the P and T vectors are pressure and tension directions of the two force dipoles which are elastically equivalent to the shear slip in the fault plane. The terms P and T axes are known to a person skilled in the art. For the less initiated, reference is made to Aki and Richards, 1980, Quantitative Seismology, Theory and Methods, volume I, W H Freeman and Company, USA, hereby incorporated by reference, or any basic seismology textbook.

3. The Mohr-Coulomb Slip Criterion and the Four Criteria to which it Leads.

The Mohr-Coulomb slip criterion is well known to a person skilled in the art. For a less initiated person, reference is made to Jager and Cook, 1969, Fundamentals of Rock Mechanics, Chapman and Hall, London, hereby incorporated by reference, which provides a good description of this. It should be noted, however, that the Coulomb original formulation related to a homogenous medium, while in this text fault planes with different orientations are always assumed.

The Mohr-Coulomb slip criterion MCS can be written as follows (here for fault plane)

MCS=|τ|−f(σₙ−p)−t₀=0,

wherein τ is the shear slip stress, σₙ is the normal stress of the fault plane, p is the water pressure and tₒ is the shear slip strength of the fault when σₙ=p.

It should be noted that here the water pressure p is included, which is also discussed in the book by Jäger and Cook.

Our fault plane is assumed to be in the plane that maximises MCS and for this plane the following applies in shear slip (according to Jäger and Cook)

$$\frac{{σ}_{1} - {σ}_{3}}{2} - \frac{f \cdot ( {σ}_{1} + {σ}_{3} - 2 p )}{2 \sqrt{1 + {f}^{2}}} - \frac{{t}_{0}}{\sqrt{1 + {f}^{2}}} = 0 , \qquad ( 1 )$$

wherein σ₁=assumed greatest principal stress, which however in certain cases is found to be the second greatest principal stress. σ₃=smallest principal stress. Equation (1) is a limiting criterion for the magnitude of the principal stresses.

### Let

S₁=unit vector in the σᵢ direction
S₂=unit vector in the σ₂ direction, wherein σ₂ is the principal stress that is not included in Equation (1) and
S₃=unit vector in the σ₃ direction.

Then S₁ and S₂ lie in the plane that is made up by N and D. Then (according to Jäger and Cook), if the angle between N and S₁ is designated β, 2β=arctan(−1/f) and 90<2β<180. The angle α between D and S₁ then is 90−β. This provides the principal stress directions

$$\{ \begin{matrix}{S}_{1} = cos α \cdot D + sin α \cdot N \\ {S}_{3} = cos α \cdot N - sin α \cdot D \\ {S}_{2} = {S}_{3} \times {S}_{1} wherein \times designates the vector product .\end{matrix}$$

Thus, all four criteria of the stress tensor have been stated, which according to the invention are collected from the Mohr-Coulomb slip criterion.

### 4. The Stress αᵥ and its Direction

The method implies that the normal stress in one direction, Sᵥ, can be considered to be known. The stress is here designated σᵥ. The most common case is that Sᵥ is vertical and σᵥ can then normally be assumed to be

σᵥ= ρ̅_{b}·z·g

wherein ρ̅_{b} is the average density of the rock between the surface and the depth z and g is the gravitational acceleration.

Let γ₁=S₁*Sᵥ, γ₂=S₂*Sᵥ and γ₃=S₃*Sᵥ wherein S₁*Sᵥ designates the scalar product of the vectors S₁ och Sᵥ. Then according to the elasticity theory the following applies to the normal stress σᵥ

σᵥ=γ₁²σ₁+γ₂²σ₂+γ₃²σ₃. (2)

This is a second limiting criterion for the principal stresses σ₁, σ₂ and σ₃.

### 5. The Principal Stresses as a Function of a Scalar Parameter.

### Let

a=\sqrt{1+f²}−f,

b=\sqrt{1+f²}+f och

c=2t₀−2fp

for γ₂≠0 the following alternative expressions can be established based on (1) and (2) and with a scalar parameter designated s

$$\{ \begin{matrix}{σ}_{1} = s \\ {σ}_{2} = \frac{b \cdot {σ}_{v} + c \cdot {γ}_{3}^{2} - ( {γ}_{1}^{2} \cdot b + {γ}_{3}^{2} \cdot a ) s}{b \cdot {γ}_{2}^{2}} \\ {σ}_{3} = \frac{a \cdot s - c}{b}\end{matrix} \\ \{ \begin{matrix}{σ}_{1} = \frac{b \cdot s + c}{a} \\ {σ}_{2} = \frac{a \cdot {σ}_{v} - c \cdot {γ}_{1}^{2} - ( {γ}_{1}^{2} \cdot b + {γ}_{3}^{2} \cdot a ) s}{a \cdot {γ}_{2}^{2}} \\ {σ}_{3} = s\end{matrix} \\ \{ \begin{matrix}{σ}_{1} = \frac{{σ}_{v} + c \cdot a \cdot {γ}_{3}^{2} - {γ}_{2}^{2} \cdot s}{{γ}_{1}^{2} + {a}^{2} \cdot {γ}_{3}^{2}} \\ {σ}_{2} = s \\ {σ}_{3} = \frac{a \cdot {σ}_{v} - c \cdot {γ}_{1}^{2} - {γ}_{2}^{2} \cdot a \cdot s}{b \cdot {γ}_{1}^{2} + a \cdot {γ}_{3}^{2}}\end{matrix}$$

If γ₂=0 Equation (2) will have the form σᵥ=γ₁²σ₁+γ₃²σ₃ which gives

$${σ}_{1} = \frac{{σ}_{v} - {γ}_{3}^{2} \cdot {σ}_{3}}{{γ}_{1}^{2}} .$$

For γ₁≠0 this results in

$$\{ \begin{matrix}{σ}_{1} = \frac{{σ}_{v} + a \cdot c \cdot {γ}_{3}^{2}}{{γ}_{1}^{2} + {a}^{2} \cdot {γ}_{3}^{2}} \\ {σ}_{2} = s \\ {σ}_{3} = \frac{a \cdot {σ}_{v} - c \cdot {γ}_{1}^{2}}{b \cdot {γ}_{1}^{2} + a \cdot {γ}_{3}^{2}}\end{matrix}$$

For γ₁=0, there applies from Equation (2) σ_{c}=σ₃, which results in

$$\{ \begin{matrix}{σ}_{1} = \frac{{σ}_{v} \cdot b + c}{a} \\ {σ}_{2} = s \\ {σ}_{3} = {σ}_{v}\end{matrix}$$

An alternative scalar parameter which is found to be particularly convenient in the context, especially since, in contrast to σ₁, σ₂ and σ₃, it is dimensionless, is the shape factor

$$R = \frac{{σ}_{2} - {σ}_{3}}{{σ}_{1} - {σ}_{3}}$$

which provides the expressions

$$\{ \begin{matrix}{σ}_{1} = \frac{b \cdot {σ}_{v} + c \cdot {γ}_{2}^{2} + c \cdot {γ}_{3}^{2} - c \cdot {γ}_{2}^{2} \cdot R}{a ( {γ}_{2}^{2} + {γ}_{3}^{2} ) + b \cdot {γ}_{1}^{2} + {γ}_{2}^{2} ( b - a ) \cdot R} \\ {σ}_{2} = \frac{a \cdot {σ}_{v} - c \cdot {γ}_{1}^{2} + ( {σ}_{v} ( b - a ) + c ( {γ}_{1}^{2} + {γ}_{3}^{2} ) ) \cdot R}{a ( {γ}_{2}^{2} + {γ}_{3}^{2} ) + b \cdot {γ}_{1}^{2} + {γ}_{2}^{2} ( b - a ) \cdot R} \\ {σ}_{3} = \frac{a \cdot {σ}_{v} - c \cdot {γ}_{1}^{2} - c \cdot {γ}_{2}^{2} \cdot R}{a ( {γ}_{2}^{2} + {γ}_{3}^{2} ) + b \cdot {γ}_{1}^{2} + {γ}_{2}^{2} ( b - a ) \cdot R}\end{matrix}$$

Other scalar parameters are also conceivable. In all cases, the scalar represents the remaining-sixth-degree of freedom.

### 6. The Water Pressure p

The method requires that the water pressure is related to the known parameters stated above. The pressure can either be known by direct measurements or be assumed to be hydrostatic if the fault system has a conductive connection to the soil surface, or, for fault systems which do not have a conductive connection to the soil surface, it can be related to the known stress uᵥ according to the following expression:

p=σᵥ−Cₚ

wherein Cₚ is a constant independent of σᵥ and is assumed to be

$${C}_{p} = \frac{2 {t}_{0}}{a} + ( {ρ}_{b} - {ρ}_{w} ) \cdot h \cdot g$$

wherein ρ_{b} is the density of the rock, ρ_{w} the density of the water and h a length parameter as stated below.

In most applications of the method, only the average of h is required. This can be indirectly estimated using the method that is presented here, if a large number of fault planes with shear slip direction are available. Generally, h depends on the strength of the rock and its fault system. For young basalt, h=400 m is a suitable average value, while for instance granite gives average values of 600-1200 m.

### 7. Elimination of the Last-Sixth-Degree of Freedom

The still unknown scalar, for instance one of the principal stresses or R, is deter-mined by minimising the elastic deformation energy Gᵢₛₒ per unit of volume relative to a stress state which in the main case is isotropic and has the pressure σᵥ.

There are various known expressions of Gᵢₛₒ. As a function of the principal stresses, Gᵢₛₒ can be written as

Gᵢₛₒ=[(σ₁−σᵥ)²+(σ₂−σᵥ)²+(σ₃−σᵥ)²−2ν((σ₁−σᵥ)(σ₂−σᵥ)+(σ₁−σᵥ)(σ₃−σᵥ)+(σ₂−σᵥ)(σ₃−σᵥ))]/2E

Equivalently, it may, shared between compression and shear slip energy, be written as

$${G}_{iso} = \frac{{( \begin{matrix}{σ}_{1} + {σ}_{2} + \\ {σ}_{3} - 3 {σ}_{v}\end{matrix} )}^{2}}{3 K} ++ \frac{[ \begin{matrix}{( {σ}_{1} - {σ}_{v} )}^{2} + {( {σ}_{1} - {σ}_{v} )}^{2} + \\ {( {σ}_{1} - {σ}_{v} )}^{2} - ( {σ}_{1} - {σ}_{v} ) ( {σ}_{2} - {σ}_{v} ) - \\ ( {σ}_{1} - {σ}_{v} ) ( {σ}_{3} - {σ}_{v} ) - \\ ( {σ}_{2} - {σ}_{v} ) ( {σ}_{3} - {σ}_{v} )\end{matrix} ]}{6 μ}$$

wherein the compression module

$$K = \frac{E}{3 ( 1 - 2 v )}$$

and the shear slip module

$$μ = \frac{E}{2 ( 1 + v )} .$$

For each given value of the used scalar, the principal stresses can be calculated as described above and the value of the Gᵢₛₒ is obtained. The scalar value minimising Gᵢₛₒ is calculated by systematic search or by an analytic solution, for example by the derivative of Gᵢₛₒ with respect to the scalar being set to be zero. If the scalar value minimising Gᵢₛₒ results in σ₂ being greater than σᵢ, this means that the designations 1 and 2 of the principal stresses and the principal stress directions in the resulting tensor must be shifted. Before shifting, however, σ₁, σ₂ and σ₃ are to be calculated with the scalar value minimising Gᵢₛₒ. This gives the complete stress tensor of a given fault plane and the associated shear slip direction.

As mentioned above, a priori information (historically and or geologically) is often available about the normal mechanism, N vector and D vector, of major earthquakes in the region. If this reference mechanism is defined with the vectors N^{ref} and D^{ref}, the following procedure will be used.

First the method according to the main case is applied to the reference mechanism, which gives a deformation energy Gᵢₛₒ which is minimised and provides a non-isotropic stress tensor with the principal stresses σᵢ^{ref}, i=1, 2, 3 and the reference principal stress direction vectors Sᵢ^{ref}, i=1, 2, 3. After that, a function of the elastic deformation energy per unit of volume relative to the non-isotopic stress tensor is written as

$${G}_{ref} = \frac{[ \begin{matrix}{( {τ}_{11} ( s ) - {σ}_{1}^{ref} )}^{2} + {( {τ}_{22} ( s ) - {σ}_{2}^{ref} )}^{2} + {( {τ}_{33} ( s ) - {σ}_{3}^{ref} )}^{2} - \\ 2 υ ( \begin{matrix}( {τ}_{11} ( s ) - {σ}_{1}^{ref} ) ( {τ}_{22} ( s ) - {σ}_{2}^{ref} ) + ( {τ}_{11} ( s ) - {σ}_{1}^{ref} ) \\ ( {τ}_{33} ( s ) - {σ}_{3}^{ref} ) + ( {τ}_{22} ( s ) - {σ}_{2}^{ref} ) ( {τ}_{33} ( s ) - {σ}_{3}^{ref} )\end{matrix} ) + \\ 2 ( 1 + υ ) ( {( {τ}_{12} ( s ) )}^{2} + {( {τ}_{13} ( s ) )}^{2} + {( {τ}_{23} ( s ) )}^{2} )\end{matrix} ]}{2 E}$$

wherein τᵢₖ(s), i=1, 2, 3, k=1, 2, 3, are the components of the stress tensor σᵢ (s), Sᵢ, i=1, 2, 3, after coordinate transformation to the coordinate system Sᵢ^{ref}=i=1, 2, 3, ν is the Poisson ratio, E is the elasticity module and s is the scalar to be determined. Then a combination of the elastic deformation energy relative to the isotropic case and relative to the above-mentioned non-isotropic case is written as G=q·Gᵢₛₒ+(1−q)·G_{ref} and 0≦q≦1 is selected.

The remaining-sixth-degree of freedom is eliminated by determining the value of the scalar parameter which minimises the function of said combination. Finally, the determined value of the scalar parameter is inserted in the expressions of the principal stresses, which gives the principal stresses, which together with the principal stress directions constitute the six elements of the stress tensor.

Regarding the choice of q, q=1 gives the previously described main case without a priori information about the type of earthquake in the region. Of course, this is the most unbiased estimate of the stress tensor. The case q=0 is conservative, cautious, implying that the stress tensor which is most closely associated with the typical earthquakes of the region is obtained. If the mechanism of the type earthquake, N^{ref} and D^{ref}, is known, it may be expected that a q value between 0 and 1 gives the best estimate. The value is not critical and q=0.5 can be suitable.

8. If there is More than One Possible Fault Plane and Shear Slip Direction

For microearthquakes, there are usually two possible fault planes with associated shear slip directions. Their normal and shear slip vectors are designated N₁, D₁, and N₂, D₂, respectively. (Then N₁=D₂ and D₁=N₂). According to the basic method, each of the two options is to be analysed separately. The one of the two possible fault planes which gives the absolute minimum G is the actual fault plane and is used to determine the stress tensor.

It has, however, been found that in the main case with isotropic reference tensor, it is always the more vertical fault plane that is to be used to calculate the stress tensor. In a simplified embodiment of the invention, it will therefore not be investigated which case gives the absolute minimum G, but the most vertical plane is directly selected to be the correct plane.

1. A method of predicting where the next major earthquake will occur within an area based on knowledge of the stress tensor field in the area, which knowledge is composed of knowledge of the local stress field at points within the area, said method comprising determining the local stress field defined by a stress tensor with six independent elements, which has caused shear slip in the form of an earthquake independently of its magnitude, microearthquakes also being included, based on knowledge of two unit vectors perpendicular to each other, one being the normal unit vector N of the fault plane of the earthquake that occurred and the other its shear slip unit vector D which lies in the fault plane, but not necessarily knowledge of which vector is N and which is D, characterised by, for a possible fault plane,
assuming that said shear slip is the only one that is not stable according to the Mohr-Coulomb slip criterion applied to contemplated fault planes with all conceivable orientations, determining the friction coefficient f of the fault plane, calculating according to the Mohr-Coulomb slip criterion for said shear slip the principal stress directions as a function of the friction coefficient f-criteria one to three-establishing according to the Mohr-Coulomb slip criterion a relationship between two of the principal stresses-criterion four-determining the normal stress σᵥ in a known direction given by the unit vector Sᵥ,
establishing according to the elasticity theory a relationship between the normal stress σᵥ and the principal stresses-criterion five-establishing based on the fourth and fifth criteria expressions of the three principal stresses as a function of a scalar parameter,
establishing a function of the elastic deformation energy per unit of volume relative to an isotropic reference stress state with the pressure σᵥ based on said expressions of the principal stresses,
eliminating the remaining-sixth-degree of freedom by determining the value of said scalar parameter which minimises the function of said elastic deformation energy-wherein, when required, information about which vector is N and which is D can be collected from the fact that the real fault plane provides the smallest minimum elastic deformation energy, and
inserting the determined value of the scalar parameter in said expression of each principal stress, which gives the principal stresses, which together with the principal stress directions constitute the six elements of the stress tensor.

2. A method as claimed in claim 1, characterised in that the unit vectors
S₁, S₂ and S₃ in the principal stress directions are calculated from
S₁=cos α·D+sin α·N
S₃=cos α·D−sin α·D
S₂=S₃×S₁
wherein x designates the vector product, and
wherein the angle between N and S₁ is designated β, 2/β=arctan(−1/f) and
90<2β<180 and α=90−β.

3. A method as claimed in claim 1, characterised in that the principal stresses σ₁, σ₂ and σ₃, wherein σ₃ is the smallest principal stress, are calculated as
$${σ}_{1} = \frac{b \cdot {σ}_{v} + c \cdot {γ}_{2}^{2} + c \cdot {γ}_{3}^{2} - c \cdot {γ}_{2}^{2} \cdot R}{a ( {γ}_{2}^{2} + {γ}_{3}^{2} ) + b \cdot {γ}_{1}^{2} + {γ}_{2}^{2} ( b - a ) \cdot R}$$
$$\begin{matrix}{σ}_{2} = \frac{a \cdot {σ}_{v} - c \cdot {γ}_{1}^{2} + ( {σ}_{v} ( b - a ) + c ( {γ}_{1}^{2} + {γ}_{3}^{2} ) ) \cdot R}{a ( {γ}_{2}^{2} + {γ}_{3}^{2} ) + b \cdot {γ}_{1}^{2} + {γ}_{2}^{2} ( b - a ) \cdot R} \\ {σ}_{3} = \frac{a \cdot {σ}_{v} - c \cdot {γ}_{1}^{2} - c \cdot {γ}_{2}^{2} \cdot R}{a ( {γ}_{2}^{2} + {γ}_{3}^{2} ) + b \cdot {γ}_{1}^{2} + {γ}_{2}^{2} ( b - a ) \cdot R}\end{matrix}$$
wherein
$$R = \frac{{σ}_{2} - {σ}_{3}}{{σ}_{1} - {σ}_{3}} ,$$
γ₁=S₂*Sᵥ, γ₂=S₂*Sᵥ, γ=S₃*Sᵥ, a=\sqrt{1+f²}−f, b=\sqrt{1+f²}+f and c=2 t₀−2 f p, t₀=shear strength and p=water pressure.

4. A method as claimed in claim 3, characterised in that the water pressure is related to the known stress σᵥ according to
p=σᵥ−Cₚ
wherein Cₚ is a constant independent of σᵥ and is assumed to be
$${C}_{p} = \frac{2 {t}_{0}}{a} + ( {ρ}_{b} - {ρ}_{w} ) \cdot h \cdot g$$
wherein ρ_{b} is the density of the rock, ρ_{w} the density of the water and h a material-dependent parameter with the dimension length which is dependent on the strength of the rock and its fault system and which has different estimated values of different kinds of rock.

5. A method as claimed in claim 1, characterised in that the elastic deformation energy is calculated as
Gᵢₛₒ=[(σ₁−σᵥ)²+(σ₂−σᵥ)²+(σ₃−σᵥ)²−2ν((σ₁−σᵥ)+(σ₂−σᵥ)+(σ₁−σᵥ)(σ₃−σᵥ)+(σ₂−σᵥ)(σ₃−σᵥ))]/2E
wherein σ₁, σ₂ and σ₃ are the principal stresses with σ₃ as the smallest principal stress, E=elasticity module and v=Poisson ratio.

6. A method as claimed in claim 1, characterised in that the elastic deformation energy is calculated as
$${G}_{iso} = \frac{{( \begin{matrix}{σ}_{1} + {σ}_{2} + \\ {σ}_{3} - 3 {σ}_{v}\end{matrix} )}^{2}}{3 K} ++ \frac{[ \begin{matrix}{( {σ}_{1} - {σ}_{v} )}^{2} + {( {σ}_{1} - {σ}_{v} )}^{2} + \\ {( {σ}_{1} - {σ}_{v} )}^{2} - ( {σ}_{1} - {σ}_{v} ) ( {σ}_{2} - {σ}_{v} ) - \\ ( {σ}_{1} - {σ}_{v} ) ( {σ}_{3} - {σ}_{v} ) - \\ ( {σ}_{2} - {σ}_{v} ) ( {σ}_{3} - {σ}_{v} )\end{matrix} ]}{6 μ}$$
wherein σ₁, σ₂ and σ₃ are the principal stresses with σ₃ as the smallest principal stress,
$$K = \frac{E}{3 ( 1 - 2 v )}$$
is the compression module and
$$μ = \frac{E}{2 ( 1 + v )}$$
is the shear module, wherein E=elasticity module and v=Poisson ratio.

7. A method as claimed in claim 1, characterised by selecting the most vertical possible fault plane as the correct fault plane.

8. A method as claimed in claim 1, characterised by first applying the method to an earthquake mechanism that is typical of the area and has a known normal unit vector N_{ref} of the fault plane and a known shear slip unit vector D_{ref}, which gives a non-isotropic stress tensor with the reference principal stresses σᵢ^{ref}, i=1, 2, 3 and the reference principal stress direction vectors
Sᵢ^{ref}=1, 2, 3, after that
establishing a function of the elastic deformation energy per unit of volume relative to the non-isotopic stress tensor as
$${G}_{ref} = \frac{[ \begin{matrix}{( {τ}_{11} ( s ) - {σ}_{1}^{ref} )}^{2} + {( {τ}_{22} ( s ) - {σ}_{2}^{ref} )}^{2} + {( {τ}_{33} ( s ) - {σ}_{3}^{ref} )}^{2} - \\ 2 υ ( \begin{matrix}( {τ}_{11} ( s ) - {σ}_{1}^{ref} ) ( {τ}_{22} ( s ) - {σ}_{2}^{ref} ) + ( {τ}_{11} ( s ) - {σ}_{1}^{ref} ) \\ ( {τ}_{33} ( s ) - {σ}_{3}^{ref} ) + ( {τ}_{22} ( s ) - {σ}_{2}^{ref} ) ( {τ}_{33} ( s ) - {σ}_{3}^{ref} )\end{matrix} ) + \\ 2 ( 1 + υ ) ( {( {τ}_{12} ( s ) )}^{2} + {( {τ}_{13} ( s ) )}^{2} + {( {τ}_{23} ( s ) )}^{2} )\end{matrix} ]}{2 E}$$
wherein τᵢₖ(s), i=1, 2, 3, k=1, 2, 3, are the components of the stress tensor σᵢ(s), Sᵢ, i=1, 2, 3, after coordinate transformation to the coordinate system Sᵢ^{ref}, i=1, 2, 3, ν is the Poisson ratio, E is the elasticity module and s is the scalar to be determined, then establishing a combination of the elastic deformation energy Gᵢₛₒ relative to the isotropic case and relative to the above-mentioned non-isotropic case as
G=q·Gᵢₛₒ+(1−q)·G_{ref} and selecting 0≦q≦1, where 1 gives the calculation according to claim 1 and 0 gives the most cautious assessment of how close you are to an instability of the typical earthquake,
then eliminating the remaining-sixth-degree of freedom by determining the value of said scalar parameter which minimises the function of said combination, and
finally inserting the determined value of the scalar parameter in said expression of each principal stress, which gives the principal stresses, which together with the principal stress directions constitute the six elements of the stress tensor.
